(19) United States
(12) Patent Application Publication
(10) Pub. No.: US 2010/0236091 A1
(43) Pub. Date: Sep. 23, 2010

(54) Arrangement of a condensate container in a domestic laundry dryer and sensor system therefor

(75) Inventors: Lothar Dittmer, Berlin (DE); Bodo Urich, Berlin (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munich (DE)

(21) Appl. No.: 11/700,207

(22) Filed: Jan. 30, 2007

(30) Foreign Application Priority Data
Feb. 1, 2006 (DE) 10 2006 004 589.0

(51) Int. Cl. F26B 21/00; F26B 19/00

(52) U.S. Cl. 34/524; 34/89

(57) ABSTRACT

In a sensor system for a domestic laundry dryer in which a canister-shaped condensate container 5 is mounted in a receiving chamber 15, at least one sensor S₂ is used to monitor the insertion of the condensate container 5. Another sensor S₁ takes over the detection of a limiting filling level 12 of the condensate in the condensate container 5. When this level is reached, emptying of the condensate container 5 is requested by switching an audible and/or visual attention signal. This container can be removed from the inside of the loading door 6.

At least one sensor S₂ is a non-contact switch. The sensor system contains a circuit arrangement which can be influenced by the sensor or sensors S for controlling the drying program of the laundry dryer. The sensor or sensors preferably S contain magnetically influencable switches. They form a switching system comprising a magnetically influencable switching contact 1 and a magnet 2. The switching contact 1 is fixed in the frame of the loading opening 9 of the laundry dryer. The magnet 2 is arranged on a side of the float 3 guided in the condensate container, facing the switching contact 1 of the relevant sensor S₁, S₂, S₁₁, S₁₂.

The invention relates to an arrangement of a condensate container in a domestic laundry dryer and a sensor system therefor according to the preamble of claim 1, wherein the laundry dryer comprises a housing and a front loading door and the sensor system contains a first sensor for monitoring the insertion of a condensate container into a receiving chamber and a second sensor for detecting a limiting level of the canister-shaped condensate container which can be removed from its receiving chamber for emptying.

In drying appliances containing a drainless collecting container for condensate which accumulates from a condensation device arranged in the drying air stream, it is important to detect the filling level of the collecting container in order to influence the control of the drying appliance so as to avoid any overflow of the collecting container and therefore any damage to the drying appliance and/or water damage in the apartment or in the house. Moreover, in drying appliances of said type, it is important for the same reasons to check whether the collecting container which can be removed from the drying appliance for emptying is inserted or not.

Known from the German Published Examined Application 2 307 912 is a laundry dryer with a condensation device disposed in the air stream, in which the condensate is collected in a collecting container to which is attached a spring-supported condensate quantity weighing device which switches the dryer control device.

Such an arrangement is relatively expensive with regard to the space requirement in the laundry dryer and the manufacturing costs for the same.

It is the object of the invention to provide an arrangement for the condensate container and a sensor system of the type specified initially for which substantially no specific space requirement exists in the drying appliance and which can be implemented at favourable cost.

This object is achieved according to the characterising part of claim 1 in that the receiving chamber for the condensate container is mounted inside the loading door in such a manner that in the operating position of the loading door the condensate container is located at least partly inside the outer boundary of the housing of the drying appliance and the sensors contain non-contact switches and are used to control the drying program of the drying appliance and for switching on and off an audible and/or visual attention signal.

Advantageous further developments of the invention are obtained from the dependent claims. Their features can be applied in any combination within the scope of the invention.

Exemplary embodiments of the invention are explained in detail hereinafter with reference to several figures. In the figures:

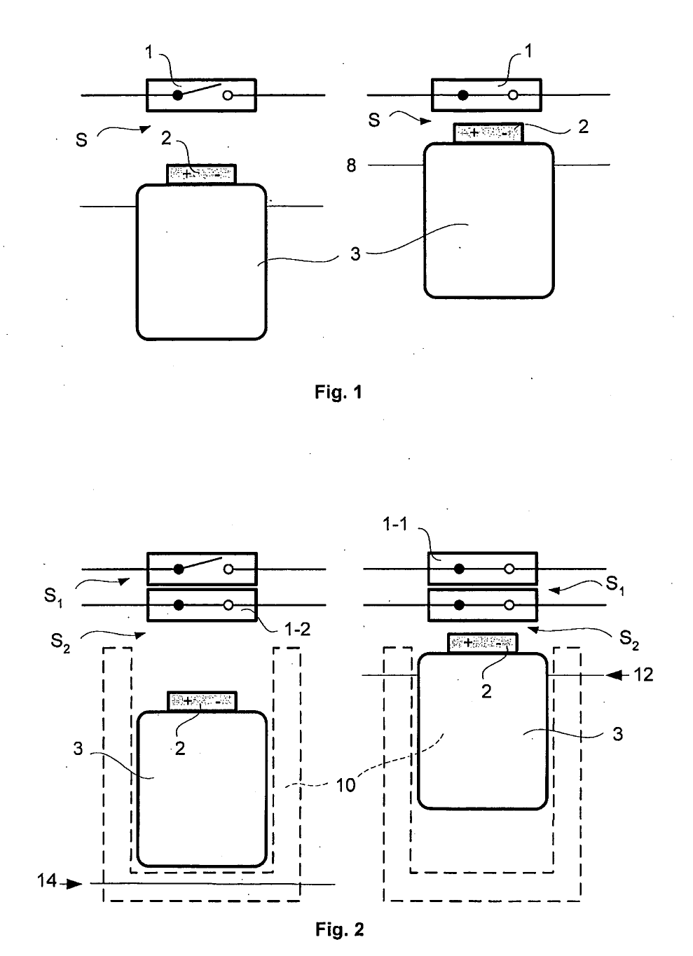

FIG. 1 is a schematic diagram of the operating principle of one exemplary embodiment of the sensor system according to the invention,

FIG. 2 is a schematic diagram of the operating principle of a further exemplary embodiment of the sensor system according to the invention,

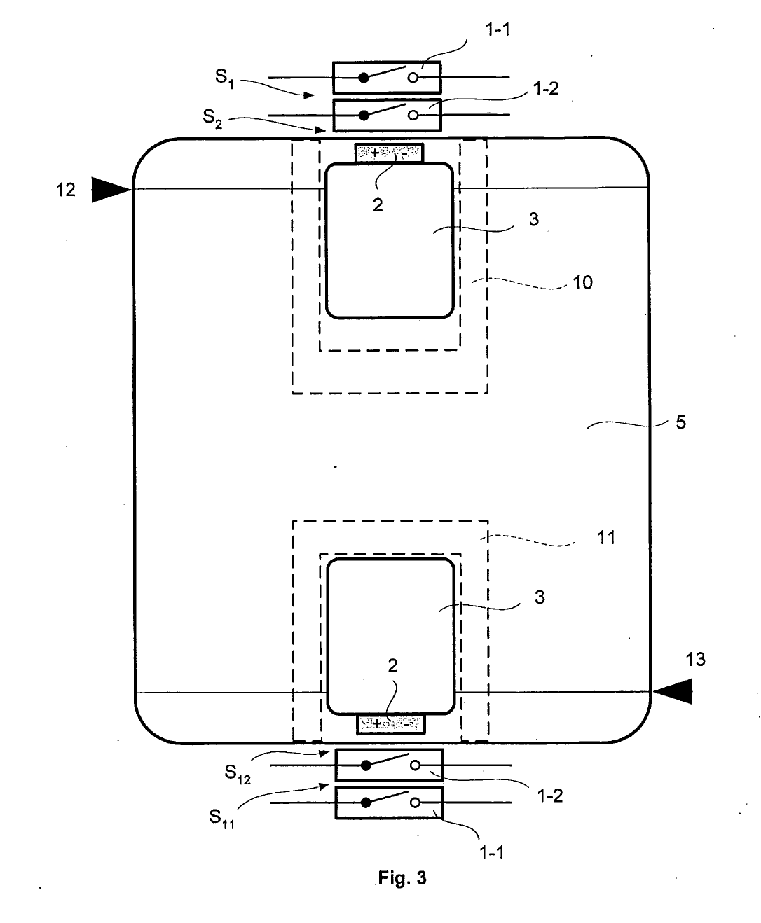

FIG. 3 is a schematic diagram of the operating principle of two variants of the sensor system according to the invention and

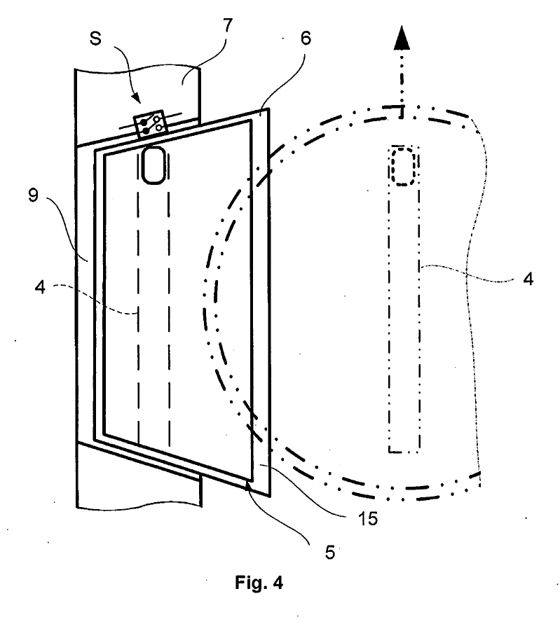

FIG. 4 is a schematic side view of a loading door of a drying appliance equipped with a condensate container.

The condensate container 5 is constructed as canister-shaped and can be provided with a folding carrying handle for transportation. The arrangement of the condensate container in the interior (receiving chamber 15) of the loading door 6 saves space and gives the best possible access for removing the container 5 upwards in the direction of the arrow (FIG. 4).

According to the invention, the sensor system for detection of the criteria “condensate container present or not present” and “condensate container full or not full” and for predictions on these states is integrated in the condensate container 5 and in the housing 7 of the laundry dryer.

According to FIG. 1, the sensor system is provided with at least one sensor S for monitoring the insertion and detection of a limiting filling level 8 of the canister-shaped condensate container (5, FIGS. 3 and 4) which can be removed from the inside of the loading door 6 for emptying. The sensor S is a non-contact switch and the sensor system contains a circuit arrangement (not shown) which can be influenced by the sensor S for controlling the drying program of the laundry dryer and for switching on or switching off an audible and/or visual attention signal. In the exemplary embodiment the sensor S contains a switch based on magnetism. This magnetic switch is a switching system comprising a magnetically influencable switching contact 1 and a magnet 2. The magnetically influencable switching contact 1 is preferably a reed contact and the magnet 2 is preferably a permanent magnet. The switching contact 1 is closed as the magnet 2 approaches, i.e. during a corresponding movement of the float 3 to which the permanent magnet 2 is attached and is conversely opened as the magnet 2 moves away, i.e. during a corresponding movement of the float 3.

The switching contact 1 is fixedly mounted in the laundry dryer, namely in the frame of the loading opening 9 (FIG. 4). The magnet 2 is arranged on a side of the float 3 facing the switching contact 1 which is arranged so that it can be moved vertically in the condensate container 5. The float 3 is guided in a cage-like vertical guide 4 on the path from bottom to top (FIG. 4) or has at least one guide housing 10 arranged in the upper part of the condensate container (FIGS. 2 and 3) for detecting the maximum filling level 12 and for monitoring the insertion and/or a corresponding guide 11 in the lower part of the condensate container 5 for detecting the minimum filling level 13 and for monitoring insertion.

FIG. 2 shows a schematic diagram of the operating mode of a further exemplary embodiment of the sensor system according to the invention. Two sensors S₁, S₂ are provided in this exemplary embodiment, one sensor S₁ being used to detect the filling level and the other sensor S₂ being used to monitor the insertion. (The circuit arrangement required for this purpose is not shown but is understandable for the person skilled in the art as in the case of the arrangement according to FIG. 1).

The sensor S₂ for monitoring the insertion must be more sensitive than the sensor S₁; this is because the float 3 is located in the lower rest position in the cage 10 during insertion of the condensate container 5 and its magnet 2 is at a relatively large distance from the switch 1-2 of the sensor S₂. The level in the container can thus be at the height 14 or lower; as soon as the condensate container is correctly inserted in the receiving chamber, the magnet 2 enters into relative proximity to the switch 1-2 and closes its Reed contact.

As soon as the float 3 rises from the bottom of the cage 10 as a result of rising level, it is only guided upwards in the cage. When the level has reached the height 12, the maximum height, the magnet 2 of the float 3 comes sufficiently close to the switch 1-1 of the sensor S₁ so that its Reed contact closes. This is the signal for the controller to interrupt the condensing process on the one hand and to signal to the user of the laundry dryer on the other hand that he can now remove and empty the condensate container 5.

The two switches 1-1 and 1-2 of the two sensors S₁ and S₂ can also be accommodated in a common housing unlike in the exemplary embodiment shown. Furthermore, the two functions “insertion monitoring” and “maximum level monitoring” can also be combined in one switch 1-1 if the circuit is skillfully designed.

FIG. 3 shows a schematic diagram of the operating principle of two variants of the sensor system according to the invention. According to one variant, the cage 10 with the float 3 for detecting the maximum filling level 12 and for monitoring the insertion is located in the upper part of the condensate container 5. According to a second variant, the cage 11 with the float 3 installed overhead for detecting a minimum filling level 13 and for monitoring the insertion is located in the lower part of the condensate container 5. Accordingly, the function “insertion monitoring” and “level monitoring” can also be spatially separated. For example, if only the insertion monitoring needs to take place in the lower part of the condensation container 5, the single switch 1-2 of the sensor S₁₂ located there must not respond more sensitively than the upper switch 1-1 of the sensor S₁ for the level monitoring.

The functional reliability of the sensor system is designed through the design installation in such a manner that a safe signal is always generated in the predefined usage position. A technically induced scatter of the magnetic field strength as well as the manufacturing tolerances of the equipment parts is taken into account here.

If the situation arises, for example, during operation of the laundry dryer that the condensate container 5 is missing or the door 6 was not closed, no switching contact can be closed on account of the function of the sensor system and it is therefore not possible to operate the laundry dryer because the opened contacts give a corresponding blocking signal to the controller of the laundry dryer.

An advantageous further development of the invention provides that at least one of the sensors S exhibits hysteresis behaviour for suppressing malfunctions and/or incorrect signals as a result of short-term fluctuations of the condensate level.

It is also possible to activate a signal after a time delay using the controller. This time delay can be used, unnoticed by the operator, to lower the temperature of the condenser for a certain time interval with the heating and condensate pump switched off and to interrupt further filling of the condensate container. A signal “container full” is only released to the outside after this interposed cooling phase.

Instead of the sensor with a magnetically influencable switching contact, the sensor system can also contain a sensor with an inductively influencable switching contact. The circuitry and design measures required for this purpose are commonly known to the person skilled in the art. For example, the float 3 can also carry a magnet 2 and the switches 1, 1-1 or 1-2 are replaced by induction coils (not shown).

The sensor system according to the invention offers further advantages as specified hereinafter:

A double sensor can be used cost-effectively,

Almost trouble-free operation and a long life can be achieved as a result of the encapsulated installation of the sensors.

No technology visible for the user is used which severely restricts the possibility of tampering.

The laundry dryer is automatically subjected to a safety testing as a result of the detection of the container insertion.

1-10. (canceled)

11. A laundry dryer comprising:
a housing and a front loading door;
a sensor system including a first sensor monitoring the insertion of a condensate container into a receiving chamber and a second sensor detecting a limiting level of the condensate container which can be removed from the receiving chamber for emptying;
wherein the receiving chamber for the condensate container is mounted inside the loading door such that the condensate container is located at least partly inside an outer boundary of the housing of the laundry dryer in an operating position of the loading door; and
the sensors include non-contact switches and control the drying program of the laundry dryer and switch on and off a signal being at least one of an audible and visual attention signal.

12. The sensor system according to claim 11, wherein the switches are arranged in a common arrangement.

13. The sensor system according to claim 11, wherein at least one of the sensors includes an inductively influencable switch.

14. The sensor system according to claim 11, wherein at least one of the sensors includes a magnetically influencable switch.

15. The sensor system according to claim 14, wherein the magnetically influencable switch includes a component of a switching system which comprises a magnetically influencable switch contact and a magnet.

16. The sensor system according to claim 15, wherein the magnetically influencable switch contact includes a reed contact and the magnet includes a permanent magnet.

17. The sensor system according to claim 15, wherein switching contact is arranged fixedly and spatially in proximity to an outer surface of the closed loading door in the housing of the laundry dryer and that the magnet is fixed on a side facing the switching contact of a float located in the condensate container.

18. The sensor system according to claim 17, wherein the float is held in a cage-like vertical guide in the condensate container for the purpose of its positioning.

19. The sensor system according to claim 17, wherein the cage-like guide extends into a lower part of the condensate container where the magnet of the float can stand opposite to a sensor for a minimum filling level.

20. The sensor system according to claim 11, wherein at least one of the sensors exhibits hysteresis behavior for suppressing at least one of malfunctions and incorrect signals as a result of short-term fluctuations of the condensate level.
